(19) United States
(12) Patent Application Publication
(10) Pub. No.: US 2024/0304205 A1
(43) Pub. Date: Sep. 12, 2024

(54) System and Method for Audio Processing using Time-Invariant Speaker Embeddings

(71) Applicant: Mitsubishi Electric Research Laboratories, Inc., Cambridge, MA (US)

(72) Inventors: Aswin Shanmugam Subramanian, Everett, MA (US); Christoph Böddeker, Paderborn (DK); Gordon Wichern, Boston, MA (US); Jonathan Le Roux, Arlington, MA (US)

(73) Assignee: Mitsubishi Electric Research Laboratories, Inc., Cambridge, MA (US)

(21) Appl. No.: 18/224,659

(22) Filed: Jul. 21, 2023

Related U.S. Application Data
(60) Provisional application No. 63/488,603, filed on Mar. 6, 2023.

(51) Int. Cl. G10L 21/0272; G10L 15/26; G10L 25/78

(52) U.S. Cl. CPC G10L 21/0272; G10L 15/26; G10L 25/78

(57) ABSTRACT

A system and method for sound processing for performing multi-talker conversation analysis is provided. The sound processing system includes a deep neural network trained for processing audio segments of an audio mixture of the multi-talker conversation. The deep neural network includes a speaker-independent layer that produces a speaker-independent output, and a speaker-biased layer applied once independently to each of the audio segments for each multiple speakers of the audio mixture. The deep neural network also processes a time-invariant embedding by individually assigning each application of the speaker-biased layer to a corresponding speaker by inputting the corresponding time-invariant speaker embedding. The deep neural network thus produces data indicative of time-frequency activity regions of each speaker of the multiple speakers in the audio mixture from a combination of speaker-biased outputs.

### TECHNICAL FIELD

This disclosure generally relates to sound processing, and more specifically to speaker separation and identification task in sound processing.

### BACKGROUND

Traditional source separation systems for extracting a target sound signal are typically intended to isolate only a particular type of sound, such as for speech enhancement or instrument de-mixing, where the target was determined by the training scheme and may not be changed at test time. Traditional source separation approaches, typically separate an audio mixture only into sources of a fixed type (for example, isolate vocals from background music), or else they separate all sources in the mixture (e.g., isolate each speaker in a meeting room) without any differentiating factor, and then use post-processing to find a target signal. Recently, conditioning-based approaches have emerged as a promising alternative, where an auxiliary input such as a class-label can be used to indicate the desired source, but the set of available conditions is typically mutually exclusive and lacks flexibility.

In the case of sound separation systems required in modern day settings, such as for meeting transcription, the sound separation task is not only concerned with separating the speakers, but also transcribing the audio recordings of meetings into machine readable text and also with enriching the transcription with detailed information of the speakers. Such information is known as diarization information, that indicates “who spoke when” in the audio mixture of the meeting. As is conventionally known, diarization is the process of separating an audio stream into different segments according to an identity of a speaker. Speaker diarization is thus, a combination of speaker segmentation and speaker clustering, where speaker segmentation deals with identification of speaker change points in the audio stream, and speaker clustering deals with grouping together speech segments based on speaker characteristics.

However, providing correct diarization information and correct meeting transcription, both are difficult tasks, specifically due to the interaction dynamics of multi-talker conversational speech. Multi-talker conversational speech involves multiple speakers articulating themselves in an intermittent manner with alternating segments of speech inactivity, single, and multi-talker speech. In particular, overlapping speech, where two or more people are talking at the same time, is known to pose a significant challenge, not only to sound processing tasks such as automatic speech recognition (ASR) but also to diarization. Additionally, the two important tasks in multi-talker speech processing-speech separation/enhancement and diarization need to be performed in correct manner, sequentially or concurrently, which greatly determines the overall quality of sound processing systems. However, there is no obvious choice whether to start the processing with diarization or with speech separation/enhancement, making the design of such sound processing systems very difficult.

With the advent of Artificial Intelligence (AI), deep learning and machine learning (ML), difficult tasks are increasingly being performed using AI/ML based systems. One popular deep learning technology that is used for diverse applications is neural networks. Neural networks can reproduce and model nonlinear processes due to which, over the last decades, neural networks have been used in numerous applications of various disciplines. Neural networks can be learned (or are trained) by processing examples, each of which contains a known “input” and “result,” forming probability-weighted associations between the two, which are stored within the data structure of the net itself. The training of a neural network from a given example is usually conducted by determining the difference between the processed output of the network (often a prediction) and a target output also referred to herein as a training label. This difference represents the error that the training aims to reduce. Hence, the network then adjusts its weighted associations according to a learning rule and using this error value. Successive adjustments will cause the neural network to produce an output that is increasingly similar to the target output. After a sufficient number of these adjustments, the training can be terminated based upon certain criteria.

This type of training is usually referred to as supervised learning. During supervised learning, the neural networks “learn” to perform tasks by considering examples, generally without being programmed with task-specific rules. For example, in image recognition, they might learn to identify images that contain cats by analyzing example images that have been labeled as “cat” or “no cat” and using the results to identify cats in other images. They do this without any prior knowledge of cats, for example, that they have fur, tails, whiskers, and cat-like faces. Instead, they automatically generate identifying characteristics from the examples that they process.

However, to perform such supervised learning, the images need to be labeled as cats or dogs. Such labeling is a tedious and laborious process. Also, in this image recognition example, the labeling is unambiguous. The images contain either cat, dog, or not cats or dogs. Such unambiguous labeling is not always possible. For example, some training applications tackle sequence problems where the timing is a variable. The time variable may create one-to-many or many-to-one ambiguity in such training where a sequence of inputs has a different length than a sequence of outputs. Sound processing systems dealing with speech transcription and speaker diarization are examples of such systems, where a long unsegmented speech/audio input needs to be processed with accuracy to generate correct and enriched transcription results.

However, due to different types and nature of tasks involved in such sound processing, different neural networks are conventionally used for performing different tasks. Increasing the number of neural networks means increasing the complexity of the overall sound processing system, which is not desired.

Accordingly, there exists a need for an advanced system that overcomes the above-stated disadvantages. To that end, there is a need for a technical solution to overcome the above-mentioned challenges. More specifically, there is need for such a system that outperforms conventional sound processing systems for enriched speech separation and speaker identification.

### SUMMARY

Simplifying structures of the devices and processes by removing elements and/or steps of operations while achieving the same result is considered advantageous for different technical fields. These advantages are evident in mechanical and civil engineering and manufacturing processes but can also benefit other technical fields such as the fields of ML and AI.

For example, many AI applications use a cascade execution of a sequence of neural networks to achieve the desired results. Each neural network in the sequence serves a specific purpose such that all neural networks can collectively achieve the desired result. Many different reasons can justify the cooperation of the plurality of neural networks. Some of those reasons are related to specifics of execution of the neural network during online testing, or specifics of offline training of the neural network. For example, in the sound processing system designed for multi-talker conversation analysis, two separate tasks of: speaker separation and speaker diarization, can be performed using two different neural networks, with each neural network trained separately for the task of interest. However, this will increase the overall complexity and computing requirements of the sound processing system, as separate effort would then need to be expended on training of each of the two neural networks. Further, at execution time, separate memory and computing resources would be required for execution of each of the neural networks.

Some embodiments are based on the recognition that for some AI applications, it is advantageous to reduce the number of neural networks used in cascade execution even if the training complexity of the neural network can be potentially increased. This is because the available computational power during the execution can be less than the computational power available during the training stage. In addition, this is because of the statistical nature of the execution and training of the neural networks.

Specifically, even having unlimited labeled training data (which is rarely the case), the training may still fail to provide a neural network trained to perform a task with a target accuracy. The reason is that the training data for training a neural network is different from the input data processed by the trained neural network, and the machine learning may need to rely on and hope that the statistical distribution of features used for processing the training data resembles the statistical distribution of the input data which is not guaranteed. Hence, each neural network in the cascade execution of a sequence of neural networks introduces statistical uncertainty.

Armed with this understanding, it is an object of some embodiments to improve the accuracy of the sound processing system configured for multi-talker conversation analysis on unsegmented long audio recordings for applications like meeting transcription. The embodiments are based on understanding that it is possible to perform this task by executing multiple neural networks. For example, it is possible to perform a conditioned diarization of speakers speaking in the recorded audio mixture given initial signatures of the voices of the speakers using a first neural network followed by a second speech separation neural network informed by the outputs of the first neural network.

However, some embodiments are based on a recognition that it is possible to reduce the number of neural networks in the abovementioned cascade execution by training a neural network that can process the audio mixture formed by utterances of multiple speakers given signatures of the voices of the speakers to extract recordings of individual speakers from the mixture. Specifically, some embodiments are based on realization that it is advantageous to perform joint diarization and separation on the input audio mixture formed by utterances of multiple speakers, as this reduces the complexity of designing and training multiple neural networks. Further, such a joint diarization and separation, when performed by a single neural network trained jointly for both the tasks, provides saving in computational requirements of the overall sound processing system designed for multi-talker conversation analysis and transcription.

Some embodiments are based on recognition that both these tasks of speaker diarization, and speaker separation are highly interdependent, and thus a joint treatment of both is highly beneficial. To that end, subtasks to be solved in either of the two are similar: while diarization is tasked to determine the speaker that is active in each time frame, mask-based source extraction for speaker separation identifies for each time-frequency (TF) bin the dominant active speaker, the difference being only the resolution, time vs time frequency.

Some embodiments are based on recognition that conventionally, joint diarization and source separation systems are based on spatial mixture models using time-varying mixture weights. There, the estimates of the prior probabilities of the mixture components, after appropriate quantization, give the diarization information about who speaks when, while the posterior probabilities have TF-resolution and can be employed to extract each source present in a mixture, either by masking or by beamforming. However, a challenge in these conventional systems is the initialization of the mixture weights or posterior probabilities. In some known systems, guided source separation (GSS) using manual annotation of the segment boundaries, and later estimates thereof, initialization of the time-varying mixture weights is done. Further, in some prior solutions, an initialization scheme that exploits the specifics of meeting data is used, where the majority of time only a single speaker is active. Thus, the clustering of short time segments leads to well distinguishable clusters, from which initial values of the parameters of the spatial mixture model can be established.

However, all of these conventional solutions to the problem of dealing with diarization and separation jointly are computationally demanding and depend on the availability of multichannel input. Furthermore, such computational demands are better dealt with in an offline algorithm that is not well suited for online or real-time processing of arbitrarily long meetings.

Some embodiments are based on the realization that the computational complexity and demands for performing joint diarization and separation can be reduced by a single neural network, such as a deep neural network, trained jointly for both the tasks.

Some embodiments are further based on the realization that conditioned diarization can be utilized to directly perform a speech extraction, that makes an additional dedicated separation or extraction system unnecessary. As is known, a conditioned diarization has only a temporal resolution for the activity estimation of each speaker, while the speech extraction is usually done with a time-frequency resolution estimate (a so-called mask). Thus, some embodiment disclose a deep neural network whose output is extended by a frequency dimension, so an overall sound processing system based on this deep neural network can be used directly for diarization and for speaker separation without an additional dedicated separation network. Doing this in such a manner eliminates the need for an additional neural network simplifying the computational and memory requirements of the multi-speaker speech separation applications.

Some embodiments are based on recognition that the task of a target speaker separation in sound processing is a processing of time-varying audio signal based on a time-varying enrolment information of each of the speakers of the multi-talker speech scenario. An example of such processing is a neural network having attention architectures. However, some embodiments are based on the recognition that time-varying enrolment information can perform poorly and be computationally inefficient, especially when the enrollment information is recorded during long meetings which contain regions of speaker inactivity.

To address this deficiency, some embodiments modify an architecture proven effective for diarization tasks so that the modified system can be used to perform speaker separation, by extending the architecture to output data indicative of time-frequency activity regions of each speaker of the multiple speakers.

As a result, some embodiments disclose a deep neural network including a speaker-independent layer applied to the audio mixture of multiple speakers and producing an output common to all of the multiple speakers and a speaker-biased layer applied repeatedly and separately for each of the multiple speakers. Each application of the speaker-biased layer is individually assigned to a corresponding speaker. The speaker-biased layer receives two types of inputs: a common input to each of the applications of the speaker-biased layer produced by the speaker-independent layer and an individual input of a speaker embedding indicative of a voice signature of a corresponding speaker. Doing this in such a manner allows us to estimate the speaker embeddings for each speaker and use them for multiple executions of the deep neural network processing different segments of the audio mixture.

Accordingly, some embodiments disclose a method for processing an audio mixture formed by one or a combination of concurrent and sequential utterances of multiple speakers. The method uses a processor coupled with stored instructions implementing the method, wherein the instructions, when executed by the processor carry out steps of the method. The steps of the method comprise receiving the audio mixture and identification information in a form of a time-invariant speaker embedding for each of the multiple speakers. The audio mixture is processed with a deep neural network including: (1) a speaker-independent layer, applied to the audio mixture of multiple speakers and producing a speaker-independent output common to all of the multiple speakers, and (2) a speaker-biased layer, applied to the speaker-independent output once independently for each of the multiple speakers to produce a speaker-biased output for each of the multiple speakers. Each application of the speaker-biased layer is individually assigned to a corresponding speaker by inputting the corresponding time-invariant speaker embedding. The deep neural network further causes extracting data indicative of time-frequency activity regions of each speaker of the multiple speakers in the audio mixture from a combination of speaker-biased outputs. The extracted data is then suitably rendered.

For example, the extracted data is rendered as a time-frequency mask, which is combined with the audio mixture and a corresponding output for a single target speaker is thus generated. In some embodiments, this output comprises a text output indicative of speech transcription data of the single speaker.

In some embodiments, the deep neural network is trained with a weakly supervised training process. In this training process, training data is in the form of time annotation data, which includes at least ground truth diarization related data and data for ground truth separated sources. Further, during said training, a diarization loss is computed based on a weak label, a separation loss is computed based on a strong label, and the deep neural network is trained using a loss obtained by combining the diarization loss and the separation loss. In some embodiments, said training is a joint training.

In some embodiments, the deep neural network further comprises a combined estimation layer that is configured for extracting the data indicative of time-frequency activity regions of each speaker of the multiple speakers.

Accordingly, some embodiments disclose a sound processing system comprising a memory storing instructions, and a processor configured to execute the stored instructions for implementing a method comprising: receiving an audio mixture formed by one or a combination of concurrent and sequential utterances of multiple speakers, and identification information in a form of a time-invariant speaker embedding for each of the multiple speakers. The audio mixture is processed with a deep neural network including: (1) a speaker-independent layer, applied to the audio mixture of multiple speakers and producing a speaker-independent output common to all of the multiple speakers, and (2) a speaker-biased layer, applied to the speaker-independent output once independently for each of the multiple speakers to produce a speaker-biased output for each of the multiple speakers, each application of the speaker-biased layer being individually assigned to a corresponding speaker by inputting the corresponding time-invariant speaker embedding. The method further comprises extracting data indicative of time-frequency activity regions of each speaker of the multiple speakers in the audio mixture from a combination of speaker-biased outputs. The extracted data is then suitably rendered.

Further features and advantages will become more readily apparent from the following detailed description when taken in conjunction with the accompanying drawings.

### BRIEF DESCRIPTION OF DRAWINGS

FIG. 1A illustrates a block diagram of a sound processing system for processing an audio mixture, in accordance with an embodiment of the present disclosure.

FIG. 1B illustrates a block diagram of operation of the sound processing system for processing an audio mixture, in accordance with an embodiment of the present disclosure

FIG. 2 illustrates a detailed block diagram of the sound processing system, in accordance with an embodiment of the present disclosure.

FIG. 3A illustrates an example architecture of a deep neural network of the sound processing system, according to an embodiment of the present disclosure.

FIG. 3B illustrates an example of training of the deep neural network using weakly supervised training strategy, according to an embodiment of the present disclosure.

FIG. 3C illustrates another example of operation of the deep neural network during different training and inference stages, according to an embodiment of the present disclosure.

FIG. 3D illustrates a schematic diagram of internal layers of the deep neural network, according to some embodiments of the present disclosure.

FIG. 4 illustrates a flow diagram of a method for performing sound processing, according to an embodiment of the present disclosure.

FIG. 5A illustrates a block diagram of an example use case of the sound processing system, according to an embodiment of the present disclosure.

FIG. 5B illustrates a block diagram of another example use case of the sound processing system, according to an embodiment of the present disclosure.

FIG. 6 shows a block diagram of the sound processing system for performing processing of audio mixture, according to some embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure. Contemplated are various changes that may be made in the function and arrangement of elements without departing from the spirit and scope of the subject matter disclosed as set forth in the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

### System Overview

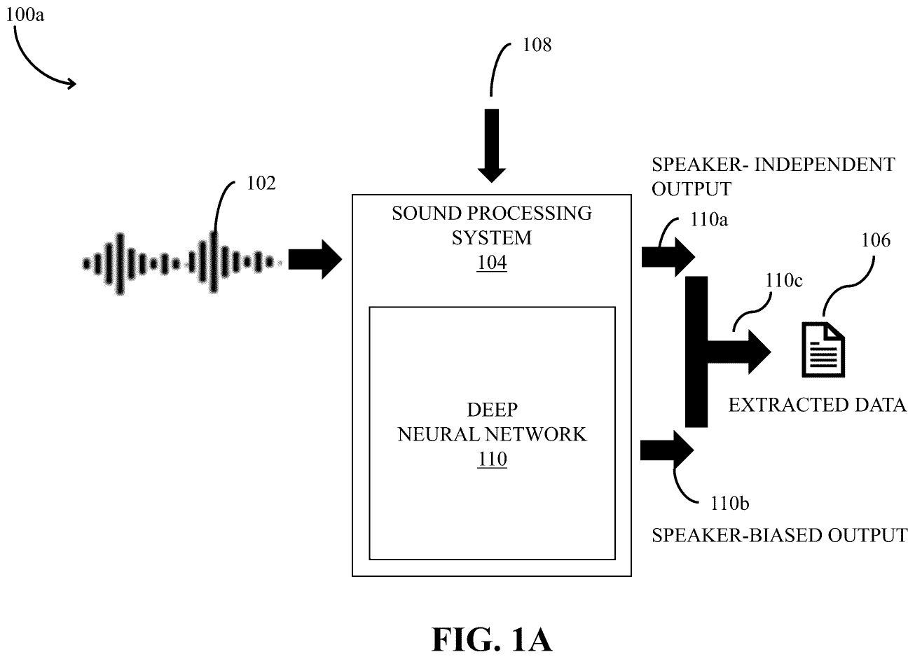

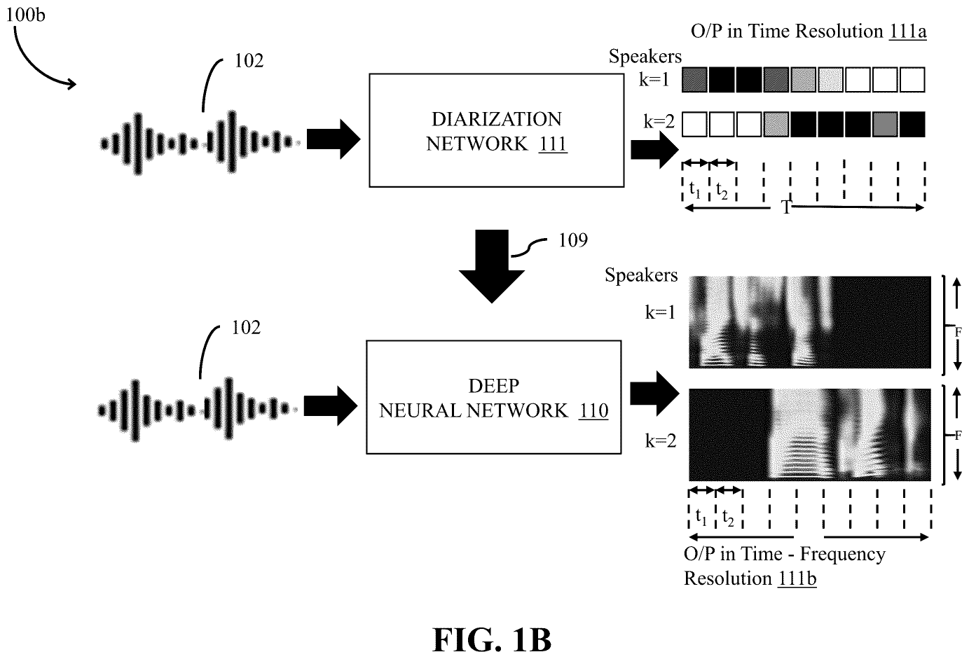

FIG. 1A illustrates a block diagram 100a of a sound processing system 104 for processing an audio mixture 102. The audio mixture 102 may correspond to a multi-talker conversation, which contains long unsegmented speech of multiple speakers. The audio mixture 102 is thus formed by one or a combination of concurrent and sequential utterances of the multiple speakers. For example, the audio mixture 102 may be captured during a meeting involving multiple participants, wherein each participant corresponds to a speaker. The audio mixture 102 may be captured through a single microphone or through multiple microphones and then combined to generate the audio mixture 102 which is received at an input interface (not shown in the FIG. 1A) of the sound processing system 104.

The sound processing system 104 may be embodied as a part of an audio processing software, an audio processing system, a standalone speaker device, a meeting application, a teleconferencing system and the like. The sound processing system 104 may also be embodied as a part of a remote software, such as a platform, a remote server, a computing system and the like, that can receive the audio mixture 102 through a communication channel and perform processing. The sound processing system 104 may be used to generate an output 106 corresponding to separated and enriched audio signals corresponding to each of the multiple speakers of the audio mixture 102. For example, the output 106 may correspond to a meeting transcript generated with identities of each of the multiple speakers that are part of the meeting conversation. In another example, the output 106 corresponds to a text output indicative of speech transcription data of the single speaker. For example, the text output is in the form of written text elaborating words spoken by each speaker.

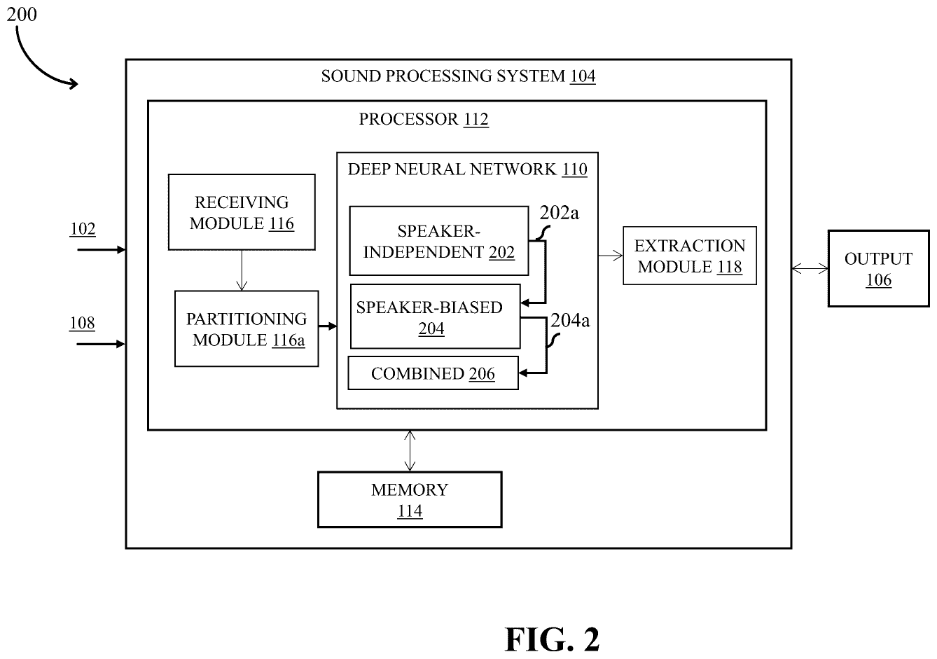

To that end, the sound processing system 104 embodied in any of the forms described above includes a memory for storing such as instructions, and a processor (shown in FIG. 2 later). The memory may be a non-transitory computer readable medium which stores data in the form of instructions or computer programs. The stored instructions are executable by the processor for achieving one or more desired objectives of the sound processing system 104. For example, one objective is to implement a method for sound processing. The method includes steps such as receiving an input, which is in the form of the audio mixture 102, which includes one or a combination of concurrent and sequential utterances of multiple speakers, and an identification information 108 for each of the multiple speakers.

The identification information 108 for each of the multiple speakers may be in the form of a time-invariant speaker embedding (hereinafter, the identification information 108 and the time-invariant speaker embedding 108 are used interchangeably to mean the same), where each speaker embedding is indicative of a voice signature of the corresponding speaker. The time-invariant speaker embedding 108 comprises a single vector of voice signatures of the multiple speakers, without any time dimension. To that end, the time-invariant speaker embedding 108 may indicate: digital representation of voices of each speaker of the multiple speakers, a bias signal associated with each of the multiple speakers, vector of speech profile of each speaker of the multiple speakers, a speaker embedding vector, and the like.

The sound processing system 104 further comprises a deep neural network 110. The deep neural network 110 comprises multiple layers including an input layer, one or more hidden layers and an output layer.

In some embodiments, the input audio mixture 102 is partitioned into a sequence of audio segments at an input of the deep neural network 110. Each of the partitioned audio segments is then processed with the deep neural network 110.

The deep neural network 110 includes a speaker-independent layer applied to the audio mixture or to the sequence of audio segments of the audio mixture 102 to produce a speaker-independent output 110a common to all of the multiple speakers.

The deep neural network 110 further comprises a speaker-biased layer applied to the speaker-independent output once independently for each of the multiple speakers. The speaker-biased layer thus produces a speaker biased output for each of the multiple speakers, and each application of the speaker-biased layer is individually assigned to a corresponding speaker by inputting the corresponding time-invariant speaker embedding 108.

In an embodiment, the speaker-biased layer is applied to each of the audio segments for each of the multiple speakers, and each application of the speaker-biased layer is individually assigned to a corresponding speaker. Further, the time-invariant speaker embedding 108 is shared between processing of different audio segments.

To that end, the speaker biased layer produces a combination of speaker-biased outputs 110b which are a combination of speaker biased outputs for each of the multiple speakers.

Further, based on the combination of speaker-biased outputs, data 110c indicative of time-frequency activity regions of each speaker of the multiple speakers is extracted by the deep neural network 110 and then suitably rendered to produce the desired output 106. The output 106 corresponds to separated and enriched audio signals corresponding to each of the multiple speakers of the audio mixture 102. In an example, the extracted data 110c comprises a time-frequency mask comprising: an estimate of the time-frequency activity regions of each speaker of the multiple speakers, subjected to a non-linearity function. The time-frequency mask is combined with the audio mixture 102 and the output 106 is generated for a single speaker from the multiple speakers based on the combination. For example, the output 106 is in the form of a signal corresponding to the speech of each single speaker of the multiple speakers, or in the form of a text output indicative of speech transcription data of each single speaker of the multiple speakers.

In this manner the deep neural network 110 is configured as a single neural network for performing diarization task, that is identifying time based activity regions of each speaker, and separation task, that is identifying time-frequency based activity regions of each speaker, by extending an intermediate output of the deep neural network 110, such as the output produced by the speaker-biased layer, in a frequency dimension, which is generally not the case. This extension of the intermediate output of the deep neural network 110 involves generating the speaker biased output 110b as a conditioned diarization output for each of multiple frequencies (which are indeed each of the multiple speakers) that are part of the input audio mixture 102. Thus, this conditioned diarization output when output per frequency, leads to generation of the speaker separation information.

To that end, the deep neural network 110 further comprises a combined estimation layer for extracting the data indicative of time-frequency activity regions of each speaker of the multiple speakers in each of the audio segments.

FIG. 1B illustrates a block diagram 100b of the operation of the sound processing system 104 including the deep neural network 110, according to an embodiment of the present disclosure. The block diagram 100b illustrates that a diarization network 111, is able to generate an output 111a in time resolution for the audio mixture 102. This output 111a contains information of speaker activity regions, such as for speakers k=1, and k=2, at different time instances T, such as at a time instance t₁, at a time instance t₂ and the like. Thus, the output 111a is a diarization output of “who spoke when” but does not provide information about the activity of each speaker within each frequency, which is required to identify and consequently separate the speakers.

However, using the deep neural network 110, this operation of the diarization network 111 is transformed 109, to provide an output 111b in time-frequency dimension. Basically, the deep neural network 110 provides the output 111b containing information of speaker activity regions of different speakers, such as the speaker k=1 and the speaker k=2, at different time instances T, such as at the time instance t₁, at the time instance t₂ and the like and at different frequencies F. As a result the output 111b comprises a time-frequency T-F domain output, which provides sufficient information to identify a speaker at each frequency, as well as the time and frequency at which that particular speaker was active and how much it was active in the output, thereby providing rich speaker separation and identification information.

This is advantageous over systems, such as the diarization network 111 and systems based on use of cascade of multiple components, or neural networks, to perform multi-talker conversation analysis on unsegmented long audio recordings for applications like meeting transcription, where the audio mixture 102 is the input. The identification of speakers in the long unsegmented recordings or speech is the task of a diarization module performed by one neural network, and then separating the recordings of each speaker is the task of a separate audio separation module, which may be based on another neural network conventionally. The interaction between the diarization and audio separation modules is critical for this task. One possible cascade relies on using an overlap-aware diarization followed by an informed separation module (e.g. target speaker extraction). However, this cascade is suboptimal and can benefit from combining them into a single module. Thus, the sound processing system 104 of FIG. 1A overcomes this disadvantage by using an architecture of a single neural network, the deep neural network 110, to perform joint conditioned diarization and separation and generating the output 106 based on this architecture. This output 106 is then extracted and rendered for the different applications, one of which is generating enriched meeting transcriptions. For example, the extracted data 110c is rendered to a speech recognition system at the output 106 for further enrichment, which is then used to produce the speaker-attributed transcription at the output 106. The use of the speaker identity information computed from the output of a preliminary diarization system makes the diarization performed by the deep neural network 110 “informed” with or “conditioned” on identification of different speakers in the audio mixture 102.

The extraction of data 110c indicative of the joint conditioned diarization and informed separation information of the multiple speakers with the deep neural network 110 used by the sound processing system 104 is advantageous as it reduces complexity of using separate neural networks or cascade of neural networks for separate tasks. Further, the deep neural network 110 comprises the neural network which is pretrained with a classification-based objective before fine-tuning with a signal reconstruction objective. The classification-based objective only tries to classify whether each of the K speakers present in the recording are actively speaking or not at each time frame. It uses a binary cross-entropy loss between the estimated and ground-truth speaker activities at each time frame. When training with the classification loss, the speech signals from multiple speakers talking simultaneously will not be separated. Once this loss converges, the speaker activity layer is copied F times to initialize F output layers that can estimate time-frequency masks, which have the ability to separate overlapping speech, and are trained with a signal reconstruction objective. Examples of signal reconstruction objectives are mean absolute error, mean square error, or signal to distortion ratio between the estimated and ground-truth speech signals for each speaker. Training the deep neural network 110 using only the signal reconstruction objective leads to inferior performance (sometimes not converging at all) compared to pretraining with a classification-based objective before fine-tuning with a signal reconstruction objective. This training schedule allows the learned neural network parameters to first be initialized with the easier classification task, before moving on to the more difficult signal reconstruction task, which has a greater possibility of the network optimization becoming stuck in a sub-optimal local minimum.

Generally, diarization has only a temporal resolution for the activity estimation of each speaker, while the speech extraction is usually done with a time-frequency resolution estimate (a so-called mask). As a result, the single deep neural network 110 performing the task of the joint conditioned diarization and separation is extended by a frequency dimension, so that the sound processing system 104 can be used directly for diarization and for speaker separation without an additional dedicated separation network. Doing in such a manner eliminates the need for an additional neural network simplifying the computational and memory requirements of the multi-speaker speech separation applications for which the sound processing system 104 can thus be used more efficiently.

FIG. 2 illustrates a detailed block diagram of the sound processing system 104 in accordance with an embodiment of the present disclosure. The sound processing system 104 includes a processor 112 and a memory 114. The memory 114 is configured to store instructions for sound processing. The operation of the sound processing system 104 may be embodied in the form of instructions, that are stored in the memory 114, and are executed by the processor 112.

In some embodiments, the memory 114 is configured to store the deep neural network 110 to facilitate processing of sound. The memory 114 corresponds to at least one of RAM, ROM, EEPROM, flash memory or other memory technology, CD-ROM, digital versatile disks (DVD) or other optical disk storage, magnetic cassettes, magnetic tape, magnetic disk storage, or any other storage medium which can be used to store the desired information, and which can be accessed by the sound processing system 104. The memory 114 includes non-transitory computer-storage media in the form of volatile and/or nonvolatile memory. The memory 114 may be removable, non-removable, or a combination thereof. Exemplary memory devices include solid-state memory, hard drives, optical-disc drives, and the like.

The memory 114 stores instructions for causing the sound processing system 104 to carry out steps of a method which enables joint diarization and separation processing on the input audio mixture 102 formed by one or a combination of concurrent and sequential utterances of multiple speakers. To that end, the processor 112 comprises a receiving module 116 that is configured to receive the input audio mixture 102. Additionally, the receiving module 116 also receives the identification information 108 discussed earlier in FIG. 1A. To that end, the receiving module 116 is configured to receive signals from one or more transmitting devices, such as one or more microphones transmitting audio signals corresponding to voice utterances of different speakers. The receiving module 116 communicates with one or more external devices or systems, or with internal modules, to exchange information or control signals. For this, the receiving module 116 is configured to communicate wirelessly or via wired connections with the transmitting devices or other compatible devices. The receiving module 116 may also store and update received signal data in the memory 114 unit for subsequent retrieval and analysis. The receiving module 116 receives power from an external power source or through a built-in power supply and may be integrated into a larger system or used as a standalone unit.

The receiving module 116 then submits the received audio mixture 102 and the identification information 108 to a partitioning module 116a. The partitioning module 116a is configured to partition the audio mixture 102 into a sequence of audio segments. For example, the audio mixture 102 is transformed to the STFT domain with a 64 ms window and 16 ms shift. In the STFT domain, the logarithmic spectrogram and mel frequency cepstral coefficients (MFCC) are stacked as input features for the deep neural network 110.

In an embodiment, the partitioning module 116a is configured to split a long unsegmented audio mixture, such as at training time of the deep neural network 110, into small segments. For example, a 10 minute long meeting recording is split into 1-minute chunks of recordings and then transmitted to the deep neural network 110.

In another example, during postprocessing, the partitioning module 116a is configured to split long activities of the audio mixture 102 at silence positions, according to activity estimates of speakers, such that no segment is longer than 12 s. In this example, as minimum segment length, 40 frames (0.64 s) are used, but this is only necessary when no overestimation is used.

Each partitioned audio segment is then processed by the deep neural network 110. The deep neural network 110 includes at least a speaker-independent layer 202 and a speaker-biased layer 204. Additionally, the deep neural network also includes a combined estimation layer 206.

The speaker-independent layer 202 is applied to the audio mixture 102 or to the sequence of audio segments produced by the portioning module 116a and produces a speaker-independent output 202a (equivalent to speaker-independent output 110a shown in FIG. 1A) common to all of the multiple speakers. The speaker-biased layer 204, is applied once independently to the speaker-independent output 202a for each of the multiple speakers, each application of the speaker-biased layer 204 is individually assigned to a corresponding speaker by the use of the time-invariant speaker embedding 108. The speaker-biased layer 204 produces a speaker-biased output 204a (equivalent to speaker-biased output 110b shown in FIG. 1A) for each speaker of the multiple speakers.

In case of partitioning, the deep neural network 110 is executed once for each of the audio segments to produce the speaker-independent output 202a and the speaker-biased layer 204 is applied, for each of the speakers, once independently to each of the audio segments to produce the speaker-biased output 204a having corresponding assignments of each speaker to the speaker-independent output 202a. During execution of the deep neural network 110, the time-invariant speaker embedding 108 is shared between processing of different audio segments of the sequence of partitioned audio segments of the audio mixture 102.

The time-invariant speaker embedding 108 is combined with the speaker-independent output 202a for each speaker of the multiple speakers to produce a combination of speaker-biased outputs 204a. The combination of the speaker-biased outputs 204a is then used to extract data indicative of time-frequency activity regions of each speaker of the multiple speakers. For this, the combination of speaker-biased outputs 204a is transmitted to a combined estimation layer 206 of the deep neural network 110.

The combined estimation layer 206 uses the combination of speaker-biased outputs 204a and provides an extract of data indicative of time-frequency activity regions of each speaker of the multiple speakers of the audio mixture 102 or in each of the audio segments of the audio mixture 102. The extracted data is provided to an extraction module 118. The extraction module 118 further processes this extracted data to provide a time-frequency mask comprising: an estimate of the time-frequency activity regions of each speaker of the multiple speakers subjected to a non-linearity function. For example, the non-linearity function may include a sigmoid operation, a softmax operation, a thresholding operation, a smoothing operation, a morphological operation, and the like.

Further, the extraction module 118 may be used to combine the extracted time-frequency mask with the audio mixture 102 and generate the output 106 for each single target speaker from the multiple speakers. This output 106 is then rendered in one or more output modalities, including, but not limited to: text, speech, audio, video, audio-video, multi-media, or a combination thereof. For example, the text modality includes speech transcription data of each speaker of the multiple speakers, along with corresponding identity of the speaker. The output 106 generated by the deep neural network 110 is very accurate and of high quality and provides reliable speech transcription data, specifically in cases of online meeting transcription applications. Further, the architecture of the deep neural network 110 described herein is an extension of a diarization neural network architecture and is more efficient and computationally feasible to implement, and requires less computational power to execute, as compared to architectures of neural networks involving cascade of neural networks, with each neural network in cascade performing a different function.

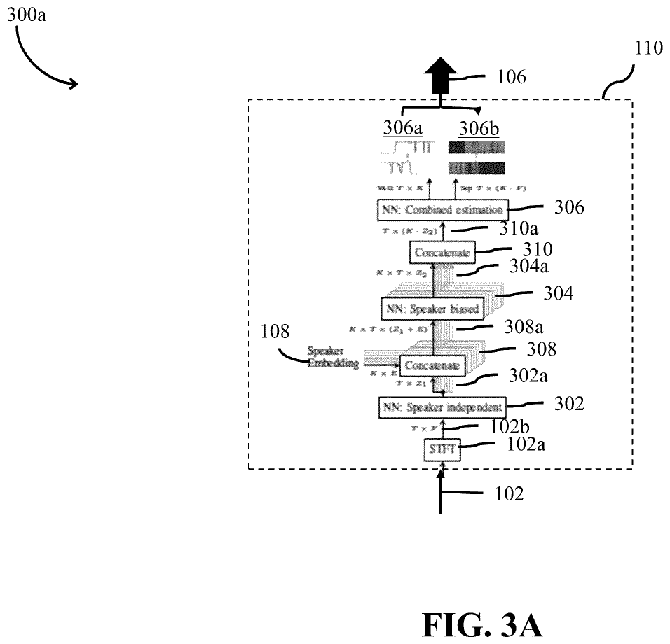

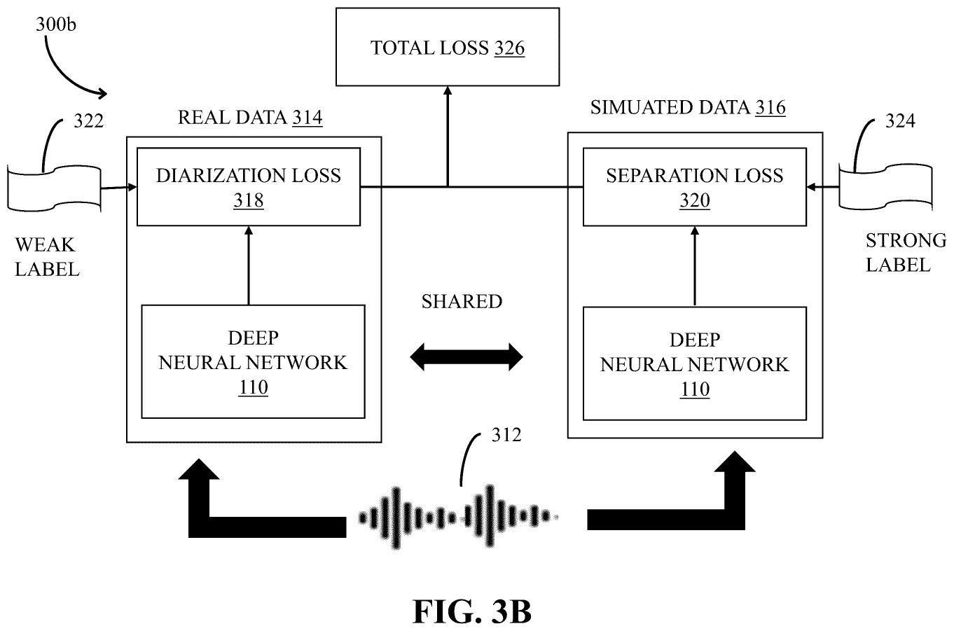

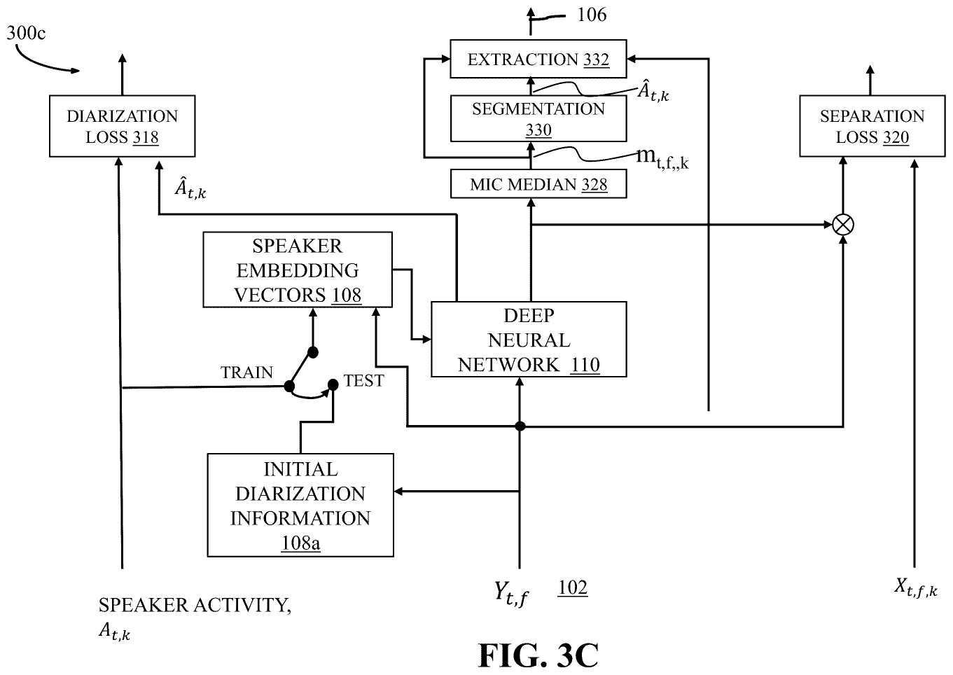

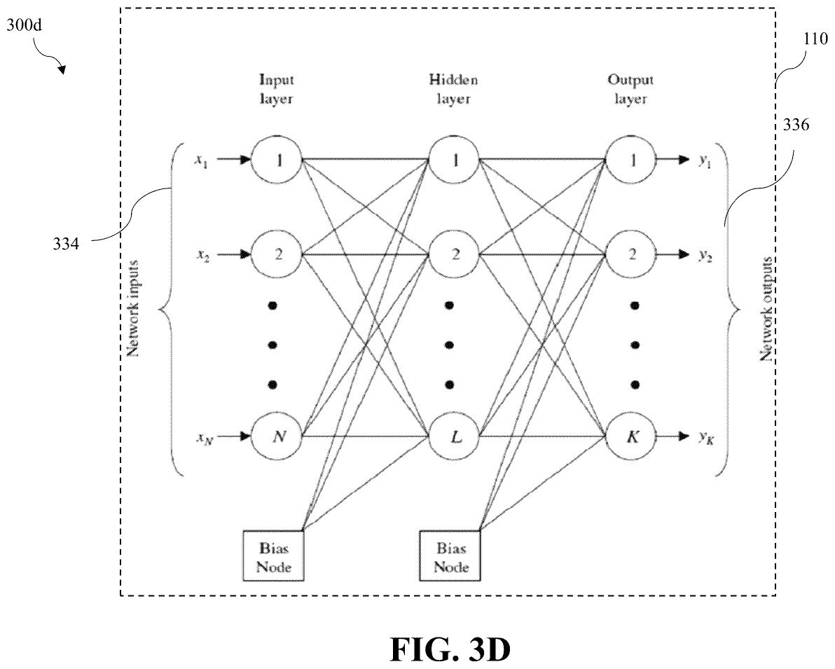

The working of different layers of the deep neural network 110 is further elaborated in the following description of FIG. 3A.

FIG. 3A illustrates an example architecture 300a of the deep neural network 110 of the sound processing system 104. The architecture 300a is used to implement the functionalities of the deep neural network 110 described earlier in FIG. 1A and FIG. 2 for performing joint conditioned diarization and speaker separation, according to an embodiment of the present disclosure.

The input audio mixture 102 is provided to the deep neural network 110 where first a Short Time Fourier Transform (STFT) operation 102a is performed by the deep neural network 110 on the audio mixture 102 to convert the audio mixture 102 to a time frequency domain as a spectrogram, which is an acoustic time-frequency domain representation of the audio mixture 102.

In the example of partitioning, the input audio mixture 102 is partitioned into a sequence of audio segments, such as by the partitioning module 116a, and these segments are then converted to a time frequency domain as a spectrogram, which is an acoustic time-frequency domain of the audio mixture 102, by the Short Time Fourier Transform (STFT) operation 102a performed by the deep neural network 110.

Generally, the spectrogram includes elements that are defined by values, such as pixels in the time-frequency domain. Each value of each of the elements is identified by a coordinate in the time-frequency domain. For instance, time frames in the time-frequency domain are represented as columns and frequency bands in the time-frequency domain are represented as rows.

The audio signal 102 is associated with voices of one or more speakers. In case of a meeting set-up, the one or more speakers are participants in the meeting. The deep neural network 110 is trained to identify each of the one or more speakers as part of a speaker separation task, as well as to identify the speech pronunciations of each speaker. In that manner, the training of the deep neural network 110 is done jointly for the two tasks: (1) separating the received audio mixture 102 into one or more segments, each of the one or more segments corresponding to a speaker of the multiple speakers, and (2) mapping the corresponding identification information for each of the speakers to the corresponding separated segments such that each of the separated segments is defined by the corresponding speaker generating an utterance associated with the segment. The deep neural network 110 is configured to operate sequentially on different tasks of processing pipeline of the sound processing system 104.

Initially, the deep neural network 110 receives audio mixture 102, and may be partitioned into the sequence of audio segments, converted to a time-frequency domain representation 102b, by the STFT operation 102a, at a speaker-independent layer 302 of the deep neural network 110 (the speaker-independent layer 302 is equivalent to the speaker-independent layer 202). The time-frequency domain representation 102b is in the form of the STFT of the input or received audio mixture 102. The STFT operation 102a is performed with a 64 ms window and 16 ms shift for an example. A time resolution is represented as T and a frequency resolution is represented as F, therefore the time-frequency domain representation 102b of the input audio mixture 102 is represented by dimensions T×F. To that end, the speaker independent layer 302 is configured to process the input audio mixture 102 into speaker-independent features based on the time-frequency characteristics of the input audio mixture 102. For example, one technique uses the features of the STFT based time-frequency representation 102b to process the input audio mixture 102 into speaker-independent features 302a of dimension T×Z₁, where Z₁ corresponds to a feature dimension referred to as speaker-independent feature dimension. In an embodiment, the speaker-independent layer 302 produces the speaker-independent features 302a in the form of embedding vectors. An example of features input into the speaker-independent layer 302 in the STFT domain are the logarithmic spectrogram and mel frequency cepstral coefficients (MFCC) stacked together. The speaker-independent features 302a output by the speaker independent layer 302 form a speaker-independent output common to all of the multiple speakers (hereinafter the speaker-independent features 302a and speaker-independent output 302a would be used interchangeably to mean the same). The speaker-independent output 302a is equivalent to the speaker-independent output 110a, and the speaker-independent output 202a.

Further, a first concatenation layer 308 is configured to concatenate or combine the speaker-independent output 302a with the time-invariant speaker embedding 108 corresponding to the identification information 108 associated with multiple speakers. The purpose of the concatenation layer 308 is to combine for each application of the speaker-biased layer 304 assigned to one of the multiple speakers, the speaker-independent output 302a with an individual input of a speaker embedding from the time-invariant speaker embedding 108 once independently for each of the multiple speakers. Each speaker embedding is indicative of the voice signature of the corresponding speaker, wherein the time-invariant speaker embedding 108 is shared between processing of different audio segments of the audio mixture 102 and the time-invariant speaker embedding remains constant for the entire execution of the deep neural network 110.

In an example, the time-invariant speaker embedding 108 comprises speaker embeddings of multiple speakers and is of dimension K×E, where K represents number of speakers, and E represents embedding dimension. The first concatenation layer 308 produces a first concatenated output 308a which is of dimension K×T×(Z₁+E) where the speaker-independent features 302a with speaker-independent feature dimension Z₁ are copied K times and each copy is concatenated to one of the K speaker embeddings with embedding dimension E. The time-invariant speaker embedding 108 embedding vector serves as a conditioning vector for multiple speakers and is concatenated to every frame of the audio mixture 102 or to every audio segment of the sequence of audio segments of the audio mixture 102 as a result of concatenation. To that end, for a meeting scenario, assuming that the total number of speakers in a meeting is known, and that embedding vectors representing the speakers are available, the deep neural network 110 is configured to estimate the activity of all speakers simultaneously. This combined estimation eventually shows high diarization performance.

Rather than relying on enrolment utterances, the speaker independent layer 302 of the deep neural network 110 estimates speaker profiles from estimated single-speaker regions of a recording to be diarized. Further, by this type of processing, the exact knowledge of the number of speakers is unnecessary, as long as a maximum number of speakers potentially present can be determined. One way to determine this maximum number of speakers is attention-based speaker identification.

The first concatenated output 308a is then passed to a speaker-biased layer 304 of the deep neural network 110, which produces a combination of speaker-biased outputs 304a of dimension K×T×Z₂ where Z₂ represents the feature dimension output of the speaker-biased layer 304, referred to as biased output feature dimension Z₂.

The speaker-biased layer 304 is applied once independently for each speaker of the multiple speakers, and to each segment of the concatenated output 308a, which in turn corresponds to each audio segment in the sequence of audio segments of the audio mixture 102. The speaker-biased layer 304 thus operates separately, in turn, on the portion of the first concatenated output 308a corresponding to each speaker, thus effectively processing K separate times an input of dimension T×(Z₁+E), and outputting an output of dimension T×Z₂, where Z₂ represents the biased output feature dimension. The output of the speaker-biased layer 304 is the combination of speaker biased outputs 304a of dimension T×Z₂ produced K times. The K outputs processed separately by the speaker-biased layer 304 considered together form the combination of the speaker-biased outputs 304a. The combination of the speaker-biased outputs 304a is equivalent to the speaker-biased output 110b and the speaker-biased output 204a.

The dimensions Z₁ and Z₂ are both hyper parameters essentially determining the size of each layer in the deep neural network 110, the speaker-independent layer 302 for Z₁, and the speaker-biased layer 304 for Z₂. In the context of neural networks, hyperparameters are parameters that are set before the learning process begins and determine the architecture and behaviour of the network. Unlike the weights and biases of the neural network, which are learned during training, hyperparameters are predefined by the user and remain constant throughout the training process.

Further, a second concatenation layer 310 is configured to concatenate, transpose, and reshape the combination of the speaker-biased outputs 304a to produce a second concatenated output 310a of dimension T×(KZ₂).

Finally, a combined estimation layer 306 is used for extracting the data indicative of time-frequency activity regions of each speaker of the multiple speakers for the audio mixture 102 or in each of the audio segments of the audio mixture 102. The time-frequency activity region of each speaker are derived on the basis of operations like thresholding and smoothing performed on the second concatenated output 310a, which is a concatenation of hidden features of all speakers in the form of one large feature matrix of dimension [symbol] ^{T×(K·Z}^{₂}⁾.

The combined estimation layer 306 is the last layer of the deep neural network 110 which is extended in a frequency dimension by replicating it F times, where F is the number of frequency bins. With this modification, the deep neural network 110 is able to produce time-frequency masks. The deep neural network 110 thus outputs data indicative of a separation output 306b. Optionally, the deep neural network 110 may also output data indicative of a diarization output 306a. It may also obtain a diarization output by further processing the separation output 306b. In this manner, the deep neural network 110 is able to perform joint conditioned diarization and separation based on the received audio mixture 102 and the time-invariant speaker embedding 108.

### Exemplar Implementation

In example, an observation yₗ, such as the mixture of audio signals 102, is a sum of K speaker signals x_{l,k} and a noise signal nₗ:

$${y}_{l} = {\sum }_{k} {x}_{l , k} + {n}_{l} ∈ {ℝ}^{M} \qquad ( 1 )$$

where [symbol] is the sample index. Here, yₗ, x_{l,k}, and nₗ are vectors of dimension M, the total number of microphones. In the case of a single-channel case, M=1. The audio mixture 102 is a long audio recording, therefore speaker signals x_{l,k} have active and inactive time intervals. Thus, a speaker activity variable a_{l,k}∈{0, 1} is considered:

$${y}_{l} = {\sum }_{k} {a}_{l , k} {x}_{l , k} + {n}_{l} \qquad ( 2 )$$

Note that a_{l,k} has no effect on the equation, because x_{l,k} is zero when a_{l,k} is zero. Going to the short-time Fourier transform (STFT) domain, we have:

$${Y}_{t , f} = {\sum }_{k} {A}_{t , k} {X}_{t , f , k} + {N}_{t , f} \qquad ( 3 )$$

where t∈{1, . . . , T} and f∈{1, . . . , F} are the time frame and frequency bin indices, and T and F are the total number of time frames and frequency bins, respectively, while Y_{t,f}, X_{t,f,k} and N_{t,f} are the STFTs of yₗ, x_{l,k}, and nₗ respectively. Further, A_{t,k}∈{0, 1} is the activity of the k-th speaker, which is derived from a_{l,k} by temporally quantizing to time frame resolution.

The deep neural network 110 is trained to predict the speech activity A_{t,k} of a target speaker k from a mixture Y_{t,f}, given an embedding Iₖ representing the speaker. The speaker embedding Iₖ is estimated from a recording instead of utilizing enrollment utterances. The speaker embedding Iₖ is equivalent to the time-invariant speaker embedding 108 and is time-invariant as it does not have any time dimension. Further, a combination layer of the deep neural network 110, such as the combined estimation layer 306, estimates the activities of all speakers in a segment of the audio mixture 102 or for the audio mixture 102 itself, simultaneously, given the time-invariant embedding 108.

### Time-Invariant Speaker Embedding Estimation

The deep neural network 110 may be configured to utilize initial identification information or initial diarization information available for the audio mixture 102, such as from manual annotation or from an embedding extraction system (e.g. X-vector) followed by a clustering approach (e.g. spectral clustering). Speaker embedding vectors (e.g. I-vectors) are then computed from those segments where only a single speaker is active:

$${I}_{k} = Emb \{ {y}_{l} ∀ l s . t . {\hat{a}}_{l , k} = 1 and {\sum }_{\overline{k} \neq k} {\hat{a}}_{l , \overline{k}} = 0 \} ∈ {ℝ}^{E} \qquad ( 4 )$$

Here, Emb{⋅} symbolizes the computation of the embedding vector Iₖ from segments of speech forming the audio mixture 102, such as from a first microphone where a single speaker is active. Furthermore, â_{l,k} is an estimate for a_{l,k}. While this example does not require an enrollment utterance, it makes the deep neural network 110 dependent on another, initial diarization system which provides the time-invariant embedding vector Iₖ as the identification information 108. Thus, the deep neural network 110 can be viewed as a refinement system: given the estimate of a first diarization, the deep neural network 110 is applied to estimate a better diarization. To that end, I-vector embeddings are preferred over X-vectors as they show a superiority of performance for diarization tasks.

### Deep Neural Network Operation

The deep neural network 110 consists of three components, the speaker-independent layer 302, the speaker-biased layer 304, and the combined estimation layer 306, with stacking operations between them, as shown in FIG. 3A.

In an example, at the speaker-independent layer 302, a logarithmic spectrogram and the logarithmic mel filterbank features of one microphone of the audio mixture 102, after optionally partitioning and conversion to STFT domain, are stacked and encoded by a few speaker-independent layers, which can be viewed as feature extraction layers, into matrices with [symbol] ^{T×Z}^{₁}, where Z₁ the size of a single framewise representation. As already discussed, the speaker-independent layer 302 provides the speaker-independent features 302a of dimension T×Z₁, where Z₁ corresponds to speaker-independent feature dimension.

Next, for each speaker k, the framewise representation is concatenated at the first concatenation layer 308 with the time-invariant speaker embedding corresponding to that speaker, resulting in the first concatenated output 308a which is provided as an input to the second network component—the speaker-biased layer 304 of dimension [symbol] ^{T×(Z}^{₁}^{+E)}. This second network component processes each speaker independently, nevertheless the speaker-biased layer 304 parameters are shared between the speakers. As a consequence, a discrimination of the speakers can only be achieved through the time-invariant speaker embedding 108, not through the speaker-biased layer 304 parameters. For each speaker, the output of the speaker-biased layer 304 has a dimension of [symbol] ^{T×Z}^{₂} with Z₂ denoting the speaker biased feature dimension, which corresponds to the size or dimension of the output size per frame.

Before the last output layers, the hidden features of all speakers are concatenated at the second concatenation layer 310 to obtain one large feature vector of dimension [symbol] ^{T×(K·Z}^{₂}⁾. In some systems based on a diarization network without separation, or during a pretraining stage of the deep neural network 110, the final layers, that is the combined estimation layer 306 may be set to produce an output of dimension [symbol] ^{T×K}, which, after thresholding and smoothing, gives the activity estimate Â_{t,k} of all speakers k and frames t simultaneously. This combined estimation makes it easier to distinguish between similar speakers.

In the deep neural network 110, at last layer, that is, the combined estimation layer 306, the output size is no longer K speakers, but K speakers times F frequency bins: [symbol] ^{T×(K·F)}. Rearranging the output from [symbol] ^{T×(K·F)} to [symbol] ^{T×K×F} a (T×F)-dimensional spectro-temporal output for each speaker k is obtained. With a sigmoid nonlinearity, which ensures that values are in [0, 1], this can be interpreted as a mask m_{t,f,k}, ∀t, f, k, that can be used for source extraction, for example via masking:

$${\hat{X}}_{t , f , k} = {m}_{t , f , k} {Y}_{t , f} . \qquad ( 5 )$$

Thus, the deep neural network 110 is able to perform separation at the output layers by providing for extraction of the mask given in equation (5) above.

Next, training for the deep neural network 110 would be described.

In an example, the deep neural network 110 is trained in two stages—a pretraining stage and a training stage. In the pretraining stage, the deep neural network 110 is trained to distinguish between multiple speakers, with the last layer producing an output of dimension T×K in [symbol] ^{T×K}. At the end of this pretraining stage, the last layer of the deep neural network 110, that is the combined estimation layer 306, is copied F times to obtain the desired time-frequency resolution, leading to a new output layer which produces an output of dimension T×(K·F) in [symbol] ^{T×(K·F)}.

After this, a second training stage is executed where the deep neural network 110 is initialized with parameters of the pretraining stage. That is, all the learnable weight and bias parameters from the neural network blocks in FIG. 3A, (the speaker independent block 302, speaker biased block 304, and combined estimation block 308) are further optimized during this second training stage in order to estimate time-frequency activity regions, as opposed to the time-activity regions used in the first stage.

The training of the deep neural network 110 may be any of: direct training, multi-purpose sequential training, multi-purpose concurrent training, weakly supervised training, or a combination thereof.

The multi-purpose sequential training comprises using a core structure of a deep neural network (DNN) with different output layers used sequentially at different training stages, wherein during a first training stage the core structure of the DNN is trained with a first output layer outputting a diarization information of the audio mixture 102, and wherein during a second training stage the first output layer is replaced with a second output layer outputting the extracted data.

The direct training comprises supervised learning of labeled speech utterances of individual speakers in the audio mixture 102.

The multi-purpose concurrent training comprises using a multi-headed neural network architecture, with different heads for generating different outputs of the extracted data, wherein the different outputs correspond to at least data indicative of speech pronunciations of each speaker forming the audio mixture, and the corresponding identification information associated with the speech pronunciations.

The weakly supervised training comprises training the deep neural network 110 based on time annotation data associated with the audio mixture 102. Generally, existing speech separation systems rely on simulated data for training of a neural network performing the task of speaker separation. However, using the methodology of weakly supervised training, the deep neural network 110 may be trained on real data, instead of simulated data, with time annotations on real data of audio mixture serving as weakly supervised labels. The weakly supervised training would be further explained in conjunction with FIG. 3B.

FIG. 3B illustrates an example schematic 300b of training of the deep neural network 110 using weakly supervised training strategy, according to an embodiment of the present disclosure.

As is known for machine learning and neural networks, supervised training involves training a neural network based on labeled data, where labels indicate ground truth values or classes of the training data. For supervised learning, it is imperative to have a large, labelled dataset. However, this may not always be possible. Therefore, FIG. 3B illustrates the example of weakly supervised training which comprises training the deep neural network 110 based on time annotation data associated with the audio mixture 102. The time annotation data consists of labels specifying the time periods when each of the k speakers in the mixture are active and inactive, but we may not have the isolated speech signals during regions of speaker overlap, hence the term weak labels. The time annotation data can be obtained by listening to the recording of the audio mixture 102 and labeling when speakers are active, so can be obtained from real data. Obtaining isolated sound signals for each speaker (specifically during regions of overlap) is not possible to obtain with real data, and fully supervised training can only be done using simulated mixture signals.

Weakly supervised training comprises training a neural network with training data that only has partial annotations or labels. For example, as shown in the schematic 300b, a training audio signal sample 312 is obtained either from a weakly labelled dataset comprising real audio mixture data 314 associated with weak labels 322, or which is generated by creating artificial audio mixtures from isolated speech signals. In the case where the training audio signal sample 312 is associated with strong labels 324, corresponding weak labels 322 may also be obtained from the strong labels 324. The real (audio mixture) data 314 may contain periods where multiple speakers are talking simultaneously, and it is not possible to obtain the isolated individual signals from each speaker. However, it is possible to obtain the time regions when each speaker in the audio mixture is actively speaking. These annotated speaker activity regions from the real data 314 correspond to the weak labels 322 in FIG. 3B. For the real data 314 it is only possible to compute the diarization loss 318 and the separation loss 320 will not be used. For the simulated data 316 the audio mixture data is artificially generated from isolated single speaker speech signals such that we have the isolated speech signal for each speaker, which corresponds to the strong labels 324. In this case strong labels mean we know the time-frequency activity regions for each speaker, as opposed to only the time-activity regions in the weak label case. For the simulated data it is possible to use the separation loss 320 as the training objective, although a combination of the diarization loss 318 and the separation loss 320 may be used for each audio signal in the simulated dataset.

Generally, speech separation systems rely on simulated data for training of a neural network performing the task of speaker separation. However, using the methodology of weakly supervised training, the deep neural network 110 may be trained on the real data 314, instead of or along with the simulated data 316, where time annotations on the real data 314 of the training audio signal sample 312 serve as weakly supervised labels 322. The time annotation data comprises ground truth data including data for diarization information and data for separated sources, derived based on ground truth estimates of activities of all speakers.

To that end, the deep neural network 110 is trained jointly to compute a diarization loss 318 based on the weak label 322 of the training audio signal sample 312, and to compute a separation loss 320 based on the strong label of the training audio signal sample 312. Further, the diarization loss 318, and the separation loss 320 are combined to determine a total loss 326 for the deep neural network 110.

Thus, the deep neural network 110 is trained in two stages-a pretraining stage and a training stage. In the pretraining stage, the deep neural network 110 is trained to distinguish between multiple speakers. At the end of this pretraining stage, the last layer of the deep neural network 110, that is the combined estimation layer 306, is copied F times to obtain the desired time-frequency resolution.

After this, a second training stage is executed where the deep neural network 110 is initialized with parameters of the pretraining stage. The parameters include the weights and biases values for each layer of the deep neural network 110 learned during the pre-training stage.

The pretraining stage uses the sum of the diarization losses between estimated and ground truth activities for all speakers. The diarization loss 318 is a binary cross entropy (BCE) loss in one example.

For the training stage, the separation loss 320 is used. The separation loss 320 is a signal reconstruction loss in an example since it implicitly accounts for phase information.

The training of the deep neural network 110 using the pretraining and the training stages is further illustrated in FIG. 3C.

FIG. 3C illustrates another example schematic 300c of operation of the deep neural network 110 during different training stages, according to an embodiment of the present disclosure.

To be specific, the separation loss 320, which is a time-domain signal reconstruction loss is computed by applying an inverse STFT to \hat{X}_{t,f,k} to obtain \hat{x}_{l,k} and measuring the logarithmic mean absolute error (Log MAE) from the ground truth x_{l,k}:

$$ℒ = {log}_{10} \frac{1}{L} {\sum }_{k} {\sum }_{l} \vert {\hat{x}}_{l , k} - {x}_{l , k} \vert , \qquad ( 6 )$$

where k is the number of speakers and l is the length of the audio signal in samples. In other examples, other loss functions, such as the mean absolute error (MAE), mean squared error (MSE), or signal-to-distortion ratio (SDR) may be employed. However, it is important to note that for reconstruction losses that contain a log operation, the sum across the speakers should be performed before applying the log operation. Otherwise, the loss is undefined, and the training can become unstable if a speaker is completely silent.

The deep neural network 110 outputs a mask m_{t,f,k} for a given TF resolution. In case of multiple microphones in the sound processing system 104, the deep neural network 110 is executed multiple times for each microphone and a median over microphones is computed at a block 328 to output the mask m_{t,f,k}. Further, to get an estimate with only time resolution, a mean across all frequencies is taken, at segmentation block 330, to obtain the speaker activity estimate, Ã_{t,k}, as:

$${\tilde{A}}_{t , k} = \frac{1}{F} {\sum }_{f} {m}_{t , f , k} \qquad ( 7 )$$

Typically, this estimate has spikes for each word and is close to zero between words. To fill those gaps, thresholding and a “closing” morphological operations are used. In thresholding, the mask output Ã_{t,k} is replaced by a value of 1 if the mask value is above a threshold τ, and 0 otherwise. In the “closing” morphological operation, applied to the output of the thresholding, in a first dilation step, a sliding window is moved over the signal with a shift of one, and the maximum value inside the window is taken as the new value for its center sample; in a subsequent erosion step, same process is repeated, however with the minimum operation, leading to the final smoothed activity estimate:

$${\hat{A}}_{t , k} = Erosion ( Dilation ( δ ( {\tilde{A}}_{t , k} > τ ) ) ) \qquad ( 8 )$$

Here, τ is the threshold and δ(x) denotes the Kronecker delta which evaluates to one if x is true and zero otherwise. When the window for the dilation is larger than the window for erosion, the speech activity is overestimated. At activity change points the speakers' signals are cut, leading to segments of constant speaker activity. When the deep network 110 is trained to fill gaps of short inactivity (e.g., pauses between words), median-based smoothing may be used. But when the deep neural network 110 is trained to predict a time-frequency reconstruction mask for each speaker, typically the mask values are smaller than the speaker activity estimation values, short inactivity produces zeros and values are smaller in overlap regions than in non-overlap regions. The thresholding and closing morphological operations help to fill the gaps.

Further, at extraction block 332, at testing time, the deep neural network 110 provides at the output 106, an estimate of the signal of speaker k by multiplying the mask obtained in equation (5) with the STFT of the input speech, such as the received audio mixture 102 of the testing or evaluation time. If multi-channel input is available, an alternative to mask multiplication for source extraction is to utilize the estimated masks to compute beamformer coefficients. For beamforming, the spatial covariance matrices of the desired signal are computed as:

$${Φ}_{xx , f , b} = \frac{1}{\vert {T}_{b} \vert} {\sum }_{t ∈ {T}_{b}} {m}_{t , f , {k}_{b}} {Y}_{t , f} {Y}_{t , f}^{H} \qquad ( 9 )$$

and of the distortion:

$${Φ}_{dd , f , b} = \frac{1}{\vert {T}_{b} \vert} {\sum }_{t ∈ {T}_{b}} max ( ε , {\sum }_{\tilde{k} \neq {k}_{b}} {m}_{t , f , \tilde{k}} ) {Y}_{t , f} {Y}_{t , f}^{H} \qquad ( 10 )$$

Here, b is the segment index, T_{b} the set of frame indices that belong to segment b, k_{b} the index of the speaker active in segment b who is to be extracted, and ε=0.0001 a small value introduced for stability.

With these covariance matrices, the beamformer coefficients can be computed for example using a minimum variance distortionless response (MVDR):

$${w}_{f , b ,} = MVDR ( {Φ}_{xx , f , b} , {Φ}_{dd , f , b} ) \qquad ( 11 )$$

Finally, source extraction is performed by applying the beamformer to the input speech:

$${\hat{X}}_{t , f , {k}_{b}} = {w}_{f , b}^{H} {Y}_{t , f ,} ∀ t ∈ {T}_{b} \qquad ( 12 )$$

In an example, beamforming is combined with mask multiplication, which led to somewhat better suppression of competing speakers:

$${\hat{X}}_{t , f , {k}_{b}} = {w}_{f , b}^{H} {Y}_{t , f} max ( {m}_{t , f , {k}_{b}} , ξ ) ∀ t ∈ {T}_{b} \qquad ( 13 )$$

where ξ∈[0, 1] is a lower bound/threshold for the mask.

During training in FIG. 3C, the ground truth speaker activity A_{t,k} labels at each time frame t is known, as it is used in the diarization loss 318 calculation. Thus, the time-invariant speaker embedding vector 108 containing identity information for each of the k speakers can be determined from these ground-truth activity labels. However, during testing the ground truth speaker activity A_{t,k} information is unavailable and must be estimated from the initial diarization information 108a. This is the purpose of the switch between the training point and the testing point in FIG. 3C.

FIG. 3D illustrates a schematic diagram 300d of internal layers of the deep neural network 110, according to some embodiments of the present disclosure. The deep neural network 110 may be a network or circuit of an artificial neural network, composed of artificial neurons or nodes. Thus, the deep neural network 110 is an artificial neural network used for solving artificial intelligence (AI) problems. The connections of biological neurons are modeled in the artificial neural networks as weights between nodes. A positive weight reflects an excitatory connection, while a negative weight values mean inhibitory connections. All inputs 334 of the deep neural network 110 may be modified by a weight and summed. Such an activity is referred to as a linear combination. Finally, an activation function controls an amplitude of an output 336 of the neural network 106. For example, an acceptable range of the output 336 is usually between 0 and 1, or it could be −1 and 1. The artificial networks may be used for predictive modeling, adaptive control and applications where they may be trained via a training dataset. Self-learning resulting from experience may occur within networks, which may derive conclusions from a complex and seemingly unrelated set of information.

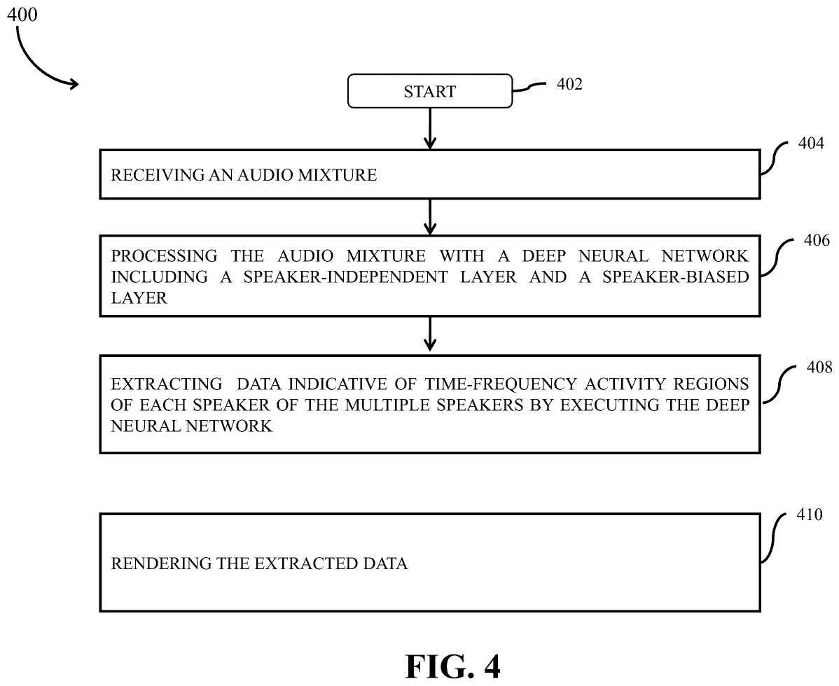

The internal structure illustrated in FIG. 3D may be used to implement different layers of deep neural network 110 to perform sound processing functions of the sound processing system 104 as described previously. FIG. 4 illustrates a flow diagram of a method 400 for performing sound processing, according to an embodiment of the present disclosure.

The method 400 is triggered at 402 when an input is detected at one or more microphones of a sound processing system, such as the sound processing system 104. Subsequent to triggering, as the input, an audio mixture and an identification information is received. As discussed in FIG. 1A, the audio mixture 102 comprises sequential and concurrent speech utterances on multiple speakers, and the sound processing system 104, at step 404, receives this audio mixture 102. The sound processing system additionally receives the identification information 108, in the form of time-invariant speaker embedding, for each of the multiple speakers of the audio mixture 102. As already discussed, the identification information 108 comprises a digital representation of a voice footprint or characteristics of voices of each speaker of the multiple speakers, in an example. Further, as discussed in FIG. 3A the identification information 108, in the form of time-invariant speaker embedding is estimated as per equation (4) by using those segments of the audio mixture 102 where only a single speaker is active. This time-invariant speaker embedding then remains constant for the entire execution of the deep neural network. Also, when the audio mixture 102 is partitioned into a sequence of audio segments, such as by the partitioning module 116a, the time-invariant speaker embedding is shared between processing of different audio segments of the sequence of audio segments.

At step 404, the audio mixture 102, or each of the audio segments of the partitioned audio mixture, is processed with a deep neural network. For example, as illustrated in FIG. 2, FIG. 3A, FIG. 3B, FIG. 3C and FIG. 3D, the deep neural network 110 is used to process the audio mixture 102. As shown in FIG. 3A, the deep neural network 110 includes the speaker-independent layer 302, applied to the audio mixture 102, after conversion to STFT domain, and producing the speaker-independent output 302a common to all of the multiple speakers. Further, the deep neural network 110 includes the speaker-biased layer 304, applied to the speaker-independent output 302a once independently to produce a speaker-biased output for each of the multiple speakers, each application of the speaker-biased layer being individually assigned to a corresponding speaker by inputting the time-invariant speaker embedding 108 corresponding to that application (though this time-invariant speaker embedding is same throughout the multiple executions of the deep neural network 110). As a result each application of the speaker-biased layer 304 is individually assigned to a corresponding speaker and produces the combination of speaker-biased outputs 304a. In case of partitioning of the audio mixture 102, the deep neural network 110 is executed once for each of the audio segments by producing the speaker-independent output 302a from the input audio mixture 102 using the speaker-independent layer 302, and combining, for each application of the speaker-biased layer 304 assigned to one of the multiple speakers, the speaker-independent output 302a with an individual input of the time-invariant speaker embedding 108 indicative of voice signature of the corresponding speaker, wherein the time-invariant speaker embedding 108 is shared between processing of different audio segments of the audio mixture 104.

At 408, data indicative of time-frequency activity regions of each speaker of the multiple speakers in each of the audio segments is extracted. For example, as shown in FIG. 3C, the deep neural network 110 is configured to output, at the block 328 the mask m_{t,f,k} ∀t, f, k, which serves as the extracted data, that can be used for source/target speaker extraction, for example via masking: \hat{X}_{t,f,k}=m_{t,f,k}Y_{t,f}.

Further, as described previously in FIG. 3C, at testing time, the deep neural network 110 provides at the output 106, an estimate of the signal of speaker k by multiplying the mask obtained in equation (5) with the STFT of the input speech, such as the received audio mixture 102 of the testing or evaluation time. If multi-channel input is available, an alternative to mask multiplication for source extraction is to utilize the estimated masks to compute beamformer coefficients.

Finally, at 410, the extracted data is suitably rendered. For example, the extracted data, such as in the form of mask, after combining with audio mixture signal of multiple speakers, provide target speaker activity data, which is used to render speech transcription for the target speaker.

In this manner, the deep neural network 110 is used to implement the method 400 in the sound processing system 104, to provide speech transcription related data for long audio recordings, using online processing of previously trained deep neural network 110.

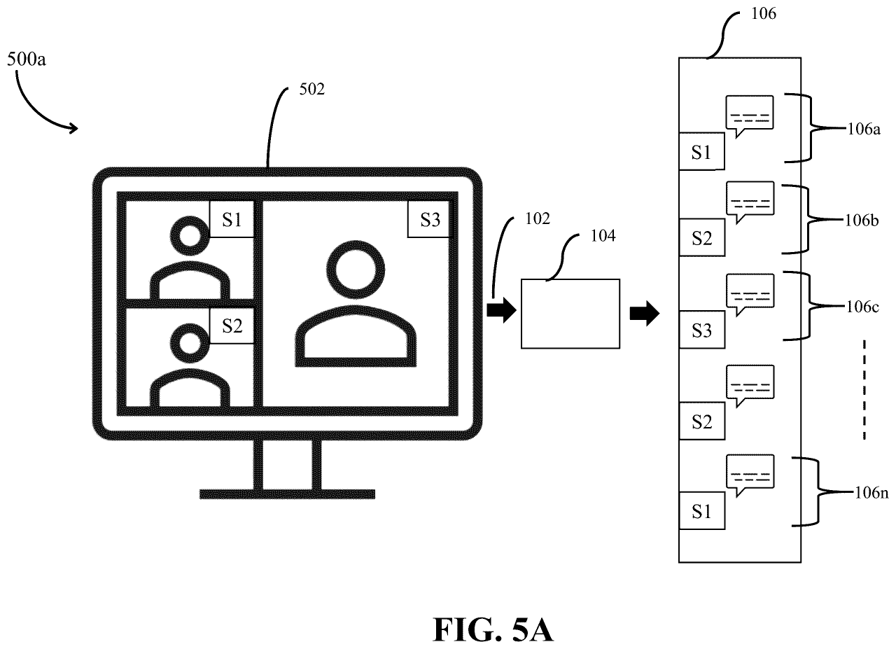

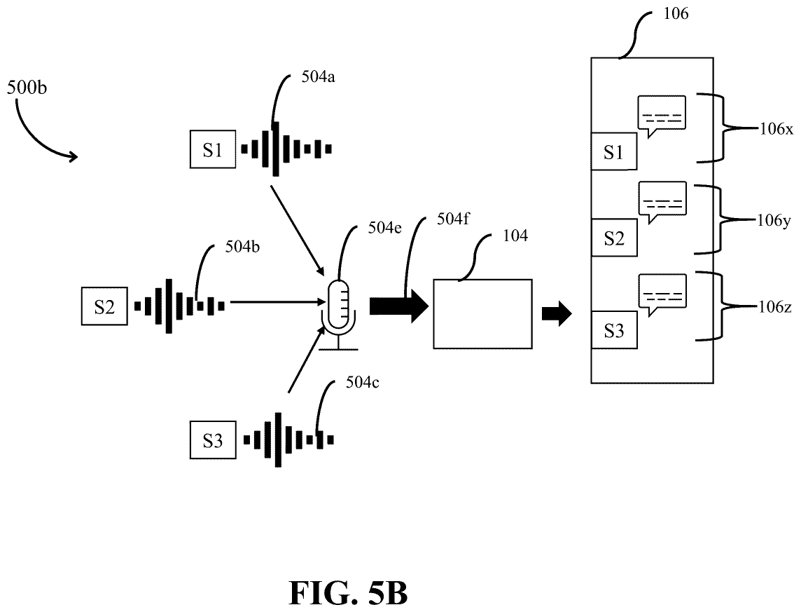

FIG. 5A illustrates a block diagram 500a of an example use case of the sound processing system 104, according to an embodiment of the present disclosure.

The block diagram 500a shows a meeting scenario, where multiple speakers, such as a speaker s1, a speaker s2, and a speaker s3 are engaged in a conversation in an online meeting through a computing device 502. The conversation corresponds to a multi-talker conversation, which produces an audio mixture, such as the audio mixture 102. The audio mixture 102 is received by the sound processing system 104, which may be embodied as a part of or may be communicatively coupled to the computing device 502. The sound processing system 104 includes deep neural network 110 described previously, which processes the audio mixture 102 and generates at an output interface, the output 106 comprising meeting transcripts of each of the multiple speakers—the speaker s1, the speaker s2, and the speaker s3, along with identification of which speaker has which transcript.

For example, the computing device 502 includes a display, where the meeting transcripts of all the speakers are displayed. For example, meeting transcript 106a corresponds to the speaker s1 at a first time instance, meeting transcript 106b corresponds to the speaker s2 at a second time instance, meeting transcript 106c corresponds to the speaker s3 at a third time instance, meeting transcript 106n corresponds to the speaker s1 at an nth time instance, and the like.

Thus, the sound processing system 104 is able to generate enriched audio transcripts for the multi-talker conversation of the speakers—the speaker s1, the speaker s2, and the speaker s3, through the use of a single deep neural network 110, and in real-time.

FIG. 5B illustrates a block diagram 500b of an example use case of the sound processing system 104, according to an embodiment of the present disclosure.

The block diagram 500b shows a meeting scenario, where multiple speakers, such as a speaker s1 having a corresponding audio signal 504a, a speaker s2 having a corresponding audio signal 504b, and a speaker s3 having a corresponding audio signal 504c are engaged in a conversation, such as in a meeting room, having a single microphone 504e. For example, the microphone 504e may be associated with a conference calling device or a teleconferencing device. Further, more than one microphones may be present in the environment represented by the block diagram 500b, but their description has been omitted for sake of brevity of the disclosure.

The microphone 504e thus provides an audio mixture 504f (which is equivalent to the audio mixture 102) formed by concurrent and/or sequential utterances of the multiple speakers—the speaker s1, the speaker s2 and the speaker s3. The audio mixture 504f is then received by the audio processing system 104 which is described in the previous embodiments and includes the deep neural network 110. The sound processing system 104 may be embodied as a part of or may be communicatively coupled to a computing device 502. The sound processing system 104 may also be a standalone computing device. In other examples, the sound processing system 104 may be an application, in the form of computer executable instructions, that are executed by a processor of a computing device to provide the functionalities described in all the previous embodiments described above. The sound processing system 104 includes deep neural network 110 described previously, which processes the audio mixture 504f and generates at an output interface, the output 106 comprising meeting transcripts of each of the multiple speakers—the speaker s1, the speaker s2, and the speaker s3, along with identification of which speaker has which transcript.

For example, meeting transcript 106x corresponds to the speaker s1 at a first time instance, meeting transcript 106y corresponds to the speaker s2 at a second time instance, and meeting transcript 106z corresponds to the speaker s3 at a third time instance, and the like.

Thus, the sound processing system 104 is able to generate enriched audio transcripts for the multi-talker conversation of the speakers—the speaker s1, the speaker s2, and the speaker s3, through the use of a single deep neural network 110, and in real-time.

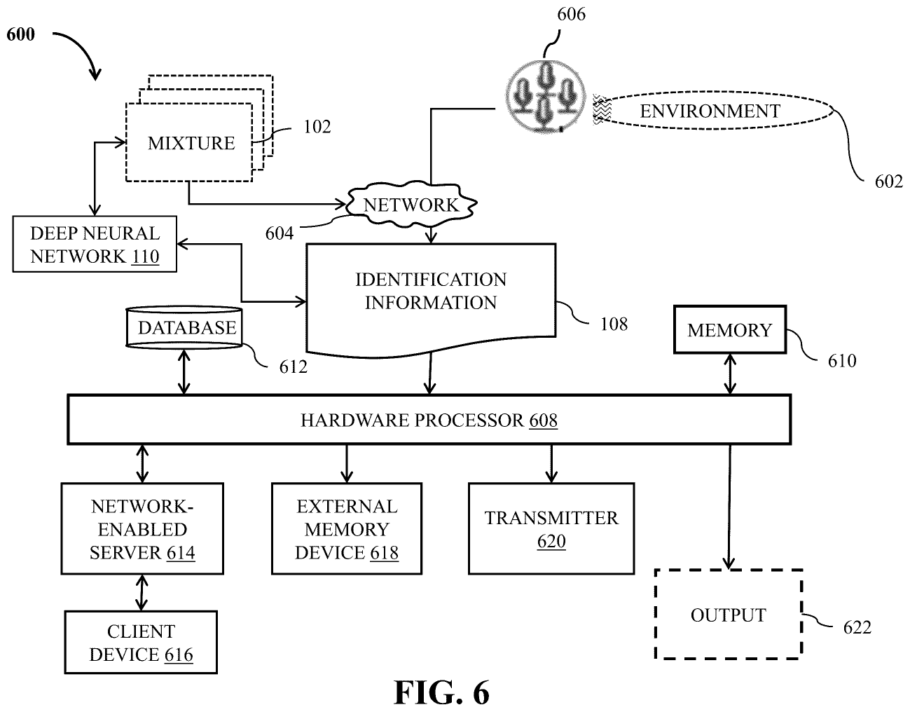

FIG. 6 shows a block diagram 600 of the sound processing system 104 for performing processing of audio mixture 102, according to some embodiments of the present disclosure. In some example embodiments, the block diagram 600 includes one or more microphones 606 that collect data including the audio mixture 102 from an environment 602.

The sound processing system 104 includes a hardware processor 608. The hardware processor 608 is in communication with a computer storage memory, such as a memory 610. The memory 610 includes stored data, including algorithms, instructions and other data that is implemented by the hardware processor 608. It is contemplated that the hardware processor 608 includes two or more hardware processors depending upon the requirements of the specific application. The two or more hardware processors are either internal or external. The sound processing system 104 is incorporated with other components including output interfaces and transceivers, among other devices.

In some alternative embodiments, the hardware processor 608 is connected to the network 604, which is in communication with a source producing the audio mixture 102. The network 604 includes but is not limited to, by non-limiting example, one or more local area networks (LANs) and/or wide area networks (WANs). The network 604 also includes enterprise-wide computer networks, intranets, and the Internet. The sound processing system 104 includes one or more number of client devices, storage components, and data sources. Each of the one or more number of client devices, storage components, and data sources comprise a device or multiple devices cooperating in a distributed environment of the network 604.

In some other alternative embodiments, the hardware processor 608 is connected to a network-enabled server 614 connected to a client device 616. The network-enabled server 614 corresponds to a dedicated computer connected to a network that run software intended to process client requests received from the client device 616 and provide appropriate responses on the client device 616. The hardware processor 608 is connected to an external memory device 618 that stores all necessary data used in the target sound signal extraction, and a transmitter 620. The transmitter 620 helps in transmission of data between the network-enabled server 614 and the client device 616. Further, an output 622 associated with the target sound signal and localization information of the target sound signal is generated.

The audio mixture 102 is further processed by the deep neural network 110. The deep neural network 110 is trained with the audio mixture 102 and the identification information 108 of multiple speakers.

The deep neural network 110 processes the audio mixture 102 and the identification information 108 and produces at the output, data indicative of: conditioned diarization information, including information of speech pronunciations of each speaker of the multiple speakers; and speaker separation information including information of corresponding identities of each speaker of the multiple speakers. Thus, a simplified architecture of the deep neural network 110 configured for performing both tasks-speaker separation and speaker diarization, without relying on enrolment data of multiple speakers.

Many modifications and other embodiments of the disclosure set forth herein will come to mind to one skilled in the art to which these disclosures pertain having the benefit of the teachings presented in the foregoing descriptions and the associated drawings. It is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method for processing an audio mixture formed by one or a combination of concurrent and sequential utterances of multiple speakers, wherein the method uses a processor coupled with stored instructions implementing the method, wherein the instructions, when executed by the processor carry out steps of the method, comprising:
receiving the audio mixture and identification information in a form of a time-invariant speaker embedding for each of the multiple speakers;
processing the audio mixture with a deep neural network including:
a speaker-independent layer, applied to the audio mixture of multiple speakers and producing a speaker-independent output common to all of the multiple speakers; and
a speaker-biased layer, applied to the speaker-independent output once independently for each of the multiple speakers to produce a speaker-biased output for each of the multiple speakers, each application of the speaker-biased layer being individually assigned to a corresponding speaker by inputting the corresponding time-invariant speaker embedding;
extracting data indicative of time-frequency activity regions of each speaker of the multiple speakers in the audio mixture from a combination of speaker-biased outputs; and
rendering the extracted data.

2. The method of claim 1, wherein the time-invariant speaker embedding remains constant for the entire execution of the deep neural network.

3. The method of claim 1 further comprising:
partitioning the audio mixture into a sequence of audio segments; and
executing the deep neural network for the sequence of audio segments, wherein the time-invariant speaker embedding is shared between processing of different audio segments of the sequence of audio segments.

4. The method of claim 1, wherein rendering the extracted data comprises outputting a time-frequency mask comprising: an estimate of the time-frequency activity regions of each speaker of the multiple speakers, subjected to a non-linearity function.

5. The method of claim 4, further comprising:
combining the outputted time-frequency mask with the audio mixture; and
generating an output for a single speaker from the multiple speakers based on the combination.

6. The method of claim 5, wherein the output for the single speaker comprises a text output indicative of speech transcription data of the single speaker.

7. The method of claim 1, wherein the deep neural network is trained with weakly supervised training process comprising training the deep neural network based on training data comprising time annotation data associated with the audio mixture.

8. The method of claim 7, wherein the deep neural network is trained on the time annotation data comprising ground truth data including: data for diarization information and data for ground-truth separated sources, such that: a diarization loss is computed based on a weak label, a separation loss is computed based on a strong label, and the deep neural network is trained using a loss obtained by combining the diarization loss and the separation loss.

9. The method of claim 1, wherein the time-invariant speaker embedding comprises a speaker embedding vector obtained on the basis of audio segments of speech forming the audio mixture, when only a single speaker is active.

10. The method of claim 1, wherein the deep neural network comprises a combined estimation layer for extracting the data indicative of time-frequency activity regions of each speaker of the multiple speakers.

11. A sound processing system comprising:
a memory for storing instructions; and
a processor for executing the stored instructions to carry out steps of a method, comprising:
receiving an audio mixture formed by one or a combination of concurrent and sequential utterances of multiple speakers, and identification information in a form of a time-invariant speaker embedding for each of the multiple speakers;
processing the audio mixture with a deep neural network including: (1) a speaker-independent layer, applied to the audio mixture of multiple speakers and producing a speaker-independent output common to all of the multiple speakers;
and (2) a speaker-biased layer, applied to the speaker-independent output once independently for each of the multiple speakers to produce a speaker-biased output for each of the multiple speakers, each application of the speaker-biased layer being individually assigned to a corresponding speaker by inputting the corresponding time-invariant speaker embedding;
extracting data indicative of time-frequency activity regions of each speaker of the multiple speakers in the audio mixture from a combination of speaker-biased outputs;
and
rendering the extracted data.

12. The sound processing system of claim 11, wherein the time-invariant speaker embedding remains constant for the entire execution of the deep neural network

13. The sound processing system of claim 11, wherein the method further comprises:
partitioning the audio mixture into a sequence of audio segments; and
executing the deep neural network for the sequence of audio segments, wherein the time-invariant speaker embedding is shared between processing of different audio segments of the sequence of audio segments.

14. The sound processing system of claim 11, wherein rendering the extracted data comprises outputting a time-frequency mask comprising: an estimate of the time-frequency activity regions of each speaker of the multiple speakers, subjected to a non-linearity function.

15. The sound processing system of claim 14, wherein the method further comprises:
combining the outputted time-frequency mask with the audio mixture; and
generating an output for a single speaker from the multiple speakers based on the combination.

16. The sound processing system of claim 15, wherein the output for the single speaker comprises a text output indicative of speech transcription data of the single speaker.

17. The sound processing system of claim 11, wherein the deep neural network is trained with weakly supervised training process comprising training the deep neural network based on time annotation data associated with the audio mixture.

18. The sound processing system of claim 17, wherein the deep neural network is trained on the time annotation data comprising ground truth data including: data for diarization information and data for ground-truth separated sources, such that: a diarization loss is computed based on a weak label, a separation loss is computed based on a strong label, and the deep neural network is trained using a loss obtained by combining the diarization loss and the separation loss.

19. The sound processing system of claim 11, wherein the time-invariant speaker embedding comprises a speaker embedding vector obtained on the basis of audio segments of speech forming the audio mixture, when only a single speaker is active.

20. The sound processing system of claim 11, wherein the deep neural network comprises a combined estimation layer for extracting the data indicative of time-frequency activity regions of each speaker of the multiple speakers.
